(19) United States
(12) Patent Application Publication
(10) Pub. No.: US 2026/0100666 A1
(43) Pub. Date: Apr. 9, 2026

(54) PROFILE AND SYSTEM FOR DIRECT MOUNTING OF SOLAR CELLS

(71) Applicant: SolteQ GmbH, Oberlangen (DE)

(72) Inventor: Berkay BAYER, Oberlangen (DE)

(73) Assignee: SolteQ GmbH, Oberlangen (DE)

(21) Appl. No.: 19/259,108

(22) Filed: Jul. 3, 2025

(30) Foreign Application Priority Data
Oct. 7, 2024 (DE) 102024128859.0

(51) Int. Cl. H02S 20/23; H02S 30/10

(52) U.S. Cl. CPC H02S 20/23; H02S 30/10

(57) ABSTRACT

A profile and a system for installation of a roof covering. The system may contain a solar cell, that permits simple and flexible installation, also directly on a waterproof and/or fireproof film, is easy to manufacture and can be used in a modular manner. The profile having on its underside a limiting element designed to engage around a panel-shaped element and thus limit the sliding of the profile onto the panel-shaped element, formed by a spacer section projecting from the underside and a section for engagement behind the panel projecting therefrom in the direction of the longitudinal extension of the profile. The profile having on its underside a protruding supporting section. The protruding supporting section may include a support lug, that protrudes further from the underside than the limiting element, and the rear engagement section, with the spacer section being part of the supporting section.

### REFERENCE TO RELATED APPLICATIONS

This application claims the benefit of German Patent Application No. 102024128859.0, filed on Oct. 7, 2024; the disclosure of which is incorporated herein by reference.

### TECHNICAL FIELD

The invention relates to a profile and a system for installation of a roof covering, in particular containing a solar cell, that permits simple and flexible installation, in particular also directly on a waterproof and/or fireproof film, is easy to manufacture and in particular can be used in a modular manner.

### SUMMARY OF THE INVENTION

At least one profile that fulfils different tasks is used for this purpose. In more complex embodiments, the system is supplemented in particular by at least one second type of structural element. For example, the profile can be connected to a solar cell array and the second structural element can be a profile with a plastic panel. In this way, solar cells and plastic panels can be mixed in a modular manner during roofing.

In further embodiments, a second profile can be installed opposite the panel or solar cell that interacts, for example, with the first profile of a neighbouring component to form a seal.

Profiles and panels or solar cells can also be separate and designed to be plugged together. This further increases flexibility.

It is fundamentally preferable for the structural elements to be matched to one another in size, in particular for them to have a uniform length and height in relation to the sections to be connected to one another. The system can also have several sizes in order to be able to install adapted sizes on different shapes and/or sizes of roof area.

The purely schematic and non-restrictive figures are described below purely by way of example for explanatory purposes. They also show preferred embodiments.

The object is achieved by a profile for covering a roof with panel-type roof coverings.
said profile having at least one recess, in particular a circular recess and/or hole, through which a screw can be inserted, in particular a wood screw and/or self-tapping screw, from one upper side to one underside of the profile.
said profile having a longitudinal extension and, in particular over at least 50% of the longitudinal extension, in particular between upper and lower sides, at least one, in particular lateral, reception section for an, in particular panel-shaped, roof covering, that extends from the reception section in particular to one side of the profile, or is connected to such a reception section,
said profile having, along its longitudinal extension, in particular over at least 50% of the length and/or of the length of the at least one reception section and or the length over which the at least one reception section is (distributed) arranged, on its upper side and extending in the direction of the longitudinal extension at least one sealing element, in particular designed as a first part and/or comb of a labyrinth seal and/or gap seal,
said profile having on its underside a limiting element designed to engage around a panel-shaped element and thus limit the sliding of the profile onto the panel-shaped element, formed by a spacer section projecting from the underside and a section for engagement behind the panel projecting therefrom in the direction of the longitudinal extension of the profile,
said profile having on its underside a protruding supporting section, in particular a support lug, that protrudes further from the underside than the limiting element, in particular the rear engagement section, with in particular the spacer section being part of the supporting section,
with the recess running in the direction of the longitudinal extension of the profile on the side of the spacer section and/or the supporting section facing away from the rear engagement section.

The object is also achieved by a system comprising two profiles, with the first profile being a profile according to one of the preceding claims and the second profile a profile for covering a roof with panel-shaped roof coverings, and
said second profile having an upper side and an underside and a longitudinal extension in the order of 10 cm less than the longitudinal extension of the first profile up to the longitudinal extension of the first profile
said profile having a longitudinal extension and over at least 50% of the longitudinal extension between upper and lower sides, at least one, in particular lateral, reception section for an, in particular panel-shaped, roof covering, or is connected to such a reception section,
said profile having, along its longitudinal extension, in particular over at least 50% of the length and/or of the length of the reception section, on its underside and extending in the direction of the longitudinal extension at least one sealing element, in particular designed as a second part and/or comb of a labyrinth seal and/or gap seal,

The upper side is in particular the side that is intended to be orientated away from the building during installation. It is arranged in particular opposite the supporting section. Laterally means in particular perpendicular to the longitudinal extension of the profile and perpendicular to the direction from the upper side to the underside.

The at least one reception section can, for example, be designed as a reception section for placement and a three-sided or four-sided boundary and/or as a slot for insertion and/or as a plurality of recesses, in particular to each receive a projection with mushroom-shaped cross-section along the longitudinal direction of the profile, in particular of a second profile of a further structural element.

Advantageously, the reception section has at least one groove running in longitudinal direction to take adhesive for bonding the panel-shaped roof covering, in particular solar cell array and/or plastic panel.

Advantageously, the first and/or second profile and/or the first and/or second reception section is designed for drainage, in particular in longitudinal direction, in particular by forming a groove extending in longitudinal direction and/or as a drain, in particular in the form of a notch, a gap and/or a hole at the end of the longitudinal extension facing away from the recess, in particular at the end of the longitudinal extension extending in the longitudinal direction and/or towards the underside. As a result, water penetrating in particular into the second reception section can run out of the profile, especially onto panel-shaped elements arranged underneath.

Advantageously, the reception section has, towards the end of the longitudinal extension facing away from the recess or at the end of the longitudinal extension, a limiting section extending perpendicular to the longitudinal extension and/or, towards the recess, a second rear engagement section extending away from the recess, which in particular extends perpendicular to the longitudinal extension beyond the reception section and/or over the entire width of the profile. The limiting section can also extend into a second reception section and/or across the entire width of the profile. In this way, a second reception section for a further panel-shaped element is created in addition to the reception section.

The recess is advantageously arranged in a fastening section projecting from the upper side, from which the second rear engagement section extends and/or which is formed with at least one rounded end, in particular also in relation to the longitudinal extension of the profile. The rounding allows the elements pushed on from above to slide off when the structural elements are mounted. The protruding fastening section allows the screw to be countersunk into it.

Advantageously, the profile has a second reception section for a panel-shaped roof covering that is directly adjacent to the first reception section, is formed parallel thereto and/or has the same length and/or has a limiting section extending perpendicularly to the longitudinal extension towards the end of the longitudinal extension facing away from the recess and/or has a second rear engagement section towards the recess extending away from the recess, which, in particular, extends perpendicularly to the longitudinal extension beyond the reception section and/or over the entire width of the profile, wherein the limiting section and/or rear engagement section are formed in particular parallel to the respective section of the first reception section and/or in one piece with the latter.

Advantageously, the supporting section is formed with a rounding that extends in particular over the entire height of the supporting section and/or on the side of the supporting section facing away from the rear engagement section. The rounding protects an underlying structure, in particular film, and prevents tears in the film.

Advantageously, the profile has a flat bar-shaped base body, which can be made of solid material or even partially hollow and, in particular, open from below by means of webs, which in particular defines the upper and lower sides as well as the longitudinal extension.

Advantageously, the profile has on one underside at least one, in particular at least two, sealing device(s) around the recess that is/are in particular circumferential, nested in one another, concentric and/or circular and, in particular concentrically, around the recess and in particular integral with the profile, in particular in the form of protruding elevations and/or recesses. This allows a hole created in a film by the screw connection to be easily sealed again.

Advantageously, the reception section is designed in such a way that when the underside of the profile is screwed onto a panel, the panel-shaped element held is prevented from lifting off perpendicular to the panel surface and/or the reception section is designed in such a way that a reception space limited towards the upper side and in particular also towards the underside is formed between the underside of the profile and the upper side of the profile and/or at least one second rear engagement element is provided above the upper side to prevent the panel-shaped element held from being lifting off.

Advantageously, the first and/or second profile and/or the plastic sheet is made of synthetic material, in particular plastic, polymer, polycarbonate and/or acrylonitrile styrene acrylate (ASA), in particular with 10 to 30% glass fibre by weight, for example Prospector HiFill ASA GF20 or Prospector Bayblend T88 GF-20.

The profile is advantageously connected, in particular bonded, to a solar cell array accommodated in the reception section, in particular comprising a carrier panel, solar cells arranged thereon and a cover panel, with the supporting section extending at least 5 mm, in particular at least 10 mm, behind the solar cell array.

A solar cell array preferably has a panel-shaped carrier, solar cells and a covering layer. It preferably does not have a metallic frame.

The profile is advantageously connected, in particular bonded, to a solar cell array accommodated in the reception section, in particular comprising a carrier panel, solar cells arranged thereon and a cover panel, with the supporting section extending at least 5 mm, in particular at least 10 mm, behind the solar cell array. This allows a gap for rear ventilation to be created behind the solar cells. In particular, the plastic panel and/or the system containing it are also designed to form an air gap, in particular that a continuous cavity is created when structural elements with solar cells and structural elements with plastic panels are combined.

The profile is advantageously connected to a plastic panel held in the reception section, in particular glued or latched, with the supporting section extending to at least 5 mm, in particular at least 10 mm, behind the plastic panel, with the panel in particular having a grid extending perpendicular to the longitudinal extension of the profile and arranged at the end of the longitudinal extension facing away from the recess. As a result, ventilation of the cavity can be achieved and/or the stability against externally exerted pressure can be improved.

Advantageously, the profile has a grid extending perpendicular to the longitudinal extension of the profile and arranged at the end of the longitudinal extension facing away from the recess. As a result, ventilation of the cavity can be achieved and/or the stability against externally exerted pressure can be improved.

In one embodiment, the reception section is designed for insertion of a panel-shaped element, in particular laterally, and has clamping elements protruding into the reception space, in particular designed to clamp a received panel-shaped element in the reception space.

Advantageously, the first or second profile and/or the first and/or second reception section and/or the plastic panel has expansion compensation lugs projecting perpendicularly to the longitudinal extension and perpendicularly to the direction from the upper to the underside and/or wherein the reception section has a lateral boundary designed such that it permits a lateral movement of the received panel-shaped element of at least 0.5 mm, in particular by elastic deformation and/or non-elastic breaking. For example, the lugs can be designed in such a way that they can be pressed into the first or second profile and/or can themselves be compressed. Lugs that break away under pressure are also conceivable. In principle, it would also be possible to assemble while keeping a gap open, but this is difficult to realise in practice, so that the expansion compensation lugs provide sufficient clearance during assembly and can also break away later and be designed to do so.

The object is also achieved by a system comprising at least one profile according to one of the preceding claims and at least one panel-shaped roof covering, in particular comprising at least two profiles and at least one solar cell array and one panel-shaped element, in particular made of plastic.

Advantageously, the solar cell array and/or plastic panel on the one hand and the (first) profile and/or the second profile on the other hand each have latching means which are designed such that they secure the solar cell array and/or plastic panel held in the reception section against removal from the reception section. This enables particularly simple and quick assembly and a high degree of modularity.

### BRIEF DESCRIPTION OF THE DRAWINGS

FIG. 1 shows two profiles each connected to a panel-shaped element.

FIG. 2 is a profile with solar cell as in FIG. 1.

FIG. 3 is an array of a plurality of such profiles from FIG. 2.

FIG. 4 a side view of the assembly on a wooden panel with foil arranged on over it.

FIG. 5 is a rear view of the profile with a solar cell and a second profile.

FIG. 6 shows the first profile from FIG. 5.

FIG. 7 shows a detail view of part of the structural element from FIG. 4.

FIG. 8 shows a detail view of the profile from FIG. 6.

FIG. 9 shows a detail view of the profile from FIG. 6.

FIG. 10 shows the right-hand profile from FIG. 1.

FIG. 11 shows right-hand structural element from FIG. 1.

FIG. 12 shows a detail view of the profile from FIG. 6.

FIG. 13 shows a left-hand part of a first profile on the right of the figure, and a solar cell array with second profile on the left of the figure.

FIG. 14 illustrates this process from top to bottom.

FIG. 15 illustrates the size and distribution of the lugs in a view looking onto the solar cell array.

### DETAILED DESCRIPTION

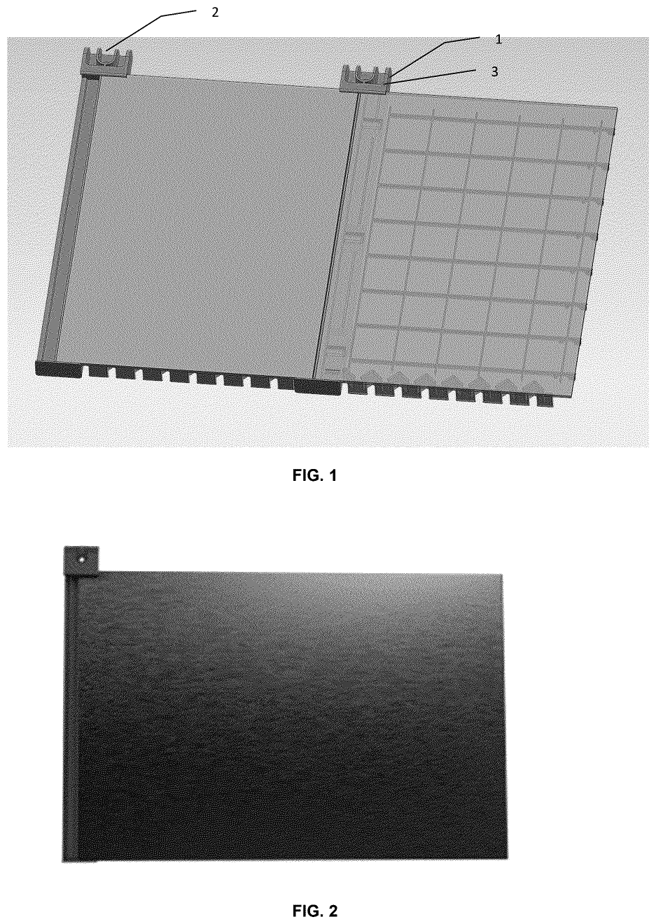

FIG. 1 shows two profiles 1 each connected to a panel-shaped element, a solar cell array on the left and a plastic panel on the right. The panel-shaped element is illustrated as semi-transparent.

During installation, the right-hand profile is first fastened with a screw through recess 2. The left-hand profile with the solar cell is then placed on top and also secured with a screw through recess 2. The left-hand part of the right-hand profile forms a second reception section and seals against the solar cell. A grid can be seen at the lower edge of the panel and the solar cell. Also shown are second rear engagement sections 3 of the profiles that secure the panel or solar cell against being lifted off upwards.

FIG. 2 shows an illustration of a profile with solar cell as in FIG. 1.

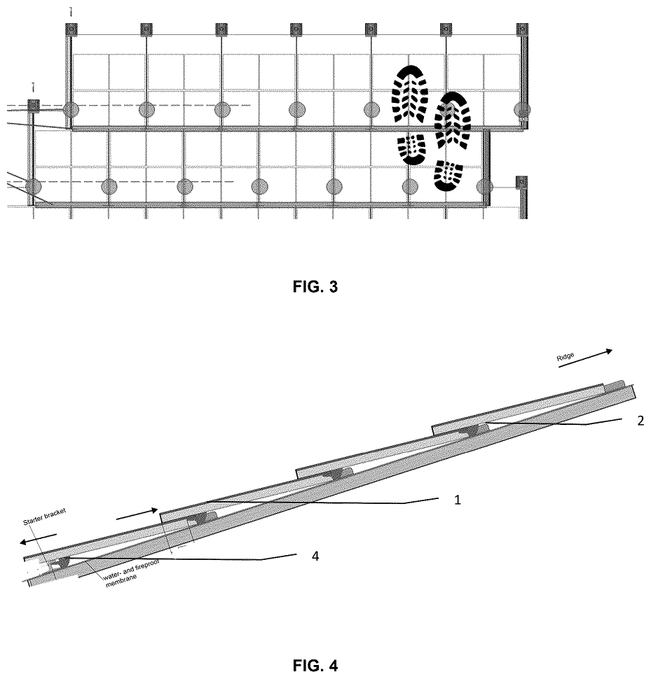

FIG. 3 shows an array of a plurality of such profiles from FIG. 2. The solar active areas are indicated by squares, four in each case.

The supporting points described below are marked with grey circles; these ensure a very good load-bearing capacity of the surface. The grids that can also serve to increase stability are highlighted with wide grey lines. It can be seen that the profiles overlap with their solar cells.

FIG. 4 shows a side view of the assembly on a wooden panel with foil arranged on over it. The profiles are screwed onto the foil. A starter bracket is screwed to the bottom. A limiting element 4 secures the profile against slipping down and its rear engagement section prevents it from being lifted off. The limiting element is part of the supporting section. The profile rests on the film with the supporting section. It can be seen that the profiles overlap with their solar cells.

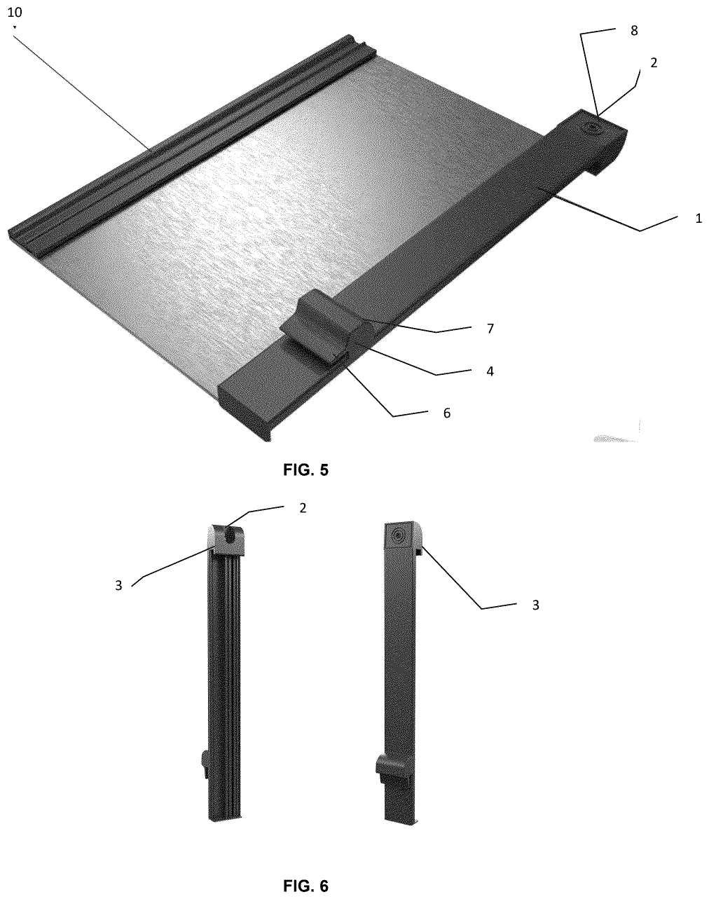

FIG. 5 shows a rear view of a profile 1 with a solar cell and a second profile 10. The profile 1 is designed as in the previous figures. It also shows a limiting element 4 that secures the profile against slipping down and its rear engagement section that prevents it from being lifted off. The limiting element is part of the supporting section 7.

It shows a recess 2 and sealing ribs 8 arranged concentrically and circularly around it and a rectangular sealing rib arranged concentrically around it.

In FIG. 2 the profile 1 is shown as part of a more complex structural element. In addition to the solar cell array bonded to the profile, it has a second profile 10 that has sealing elements at the rear to form a labyrinth seal together with the upper side of a first profile of an identical structural element.

FIG. 6 shows the first profile from FIG. 5 once again individually from different directions. The second rear engagement section 3, the recess 2 and a limiting element 12 that prevents the solar cell array from slipping downwards during bonding and provides impact protection for the solar cell array, can also be seen. The limiting element extends over the entire width of the profile into a second reception section for receiving a second profile and a solar cell array of a neighbouring structural element during assembly and thus secures the structural elements against each other together with the second rear engagement section 3 that also extends over the entire width.

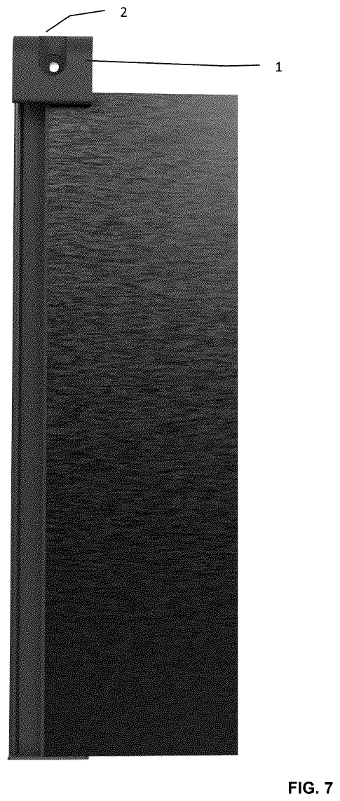

FIG. 7 shows a detail view of part of the structural element from FIG. 4.

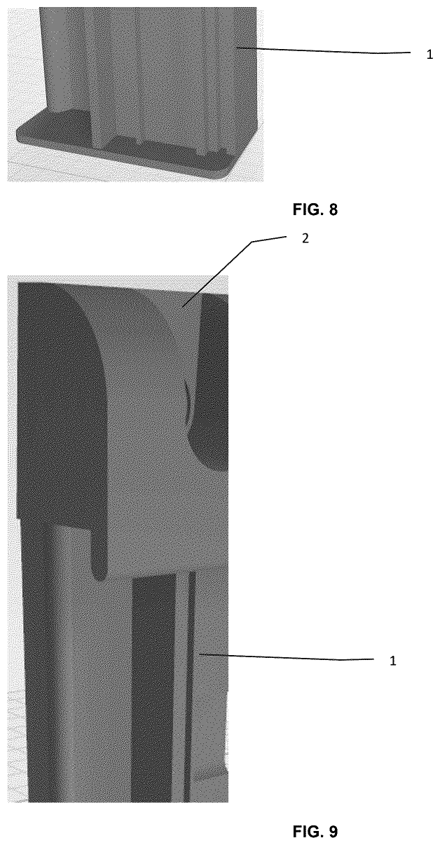

FIG. 8 shows a detail view of the profile from FIG. 6. FIG. 8 shows a detail view of the profile from FIG. 6, showing two reception sections with a web between them and the continuous limiting element at the bottom.

FIG. 9 also shows a detail view of the profile from FIG. 6 for better visibility of the second rear engagement section

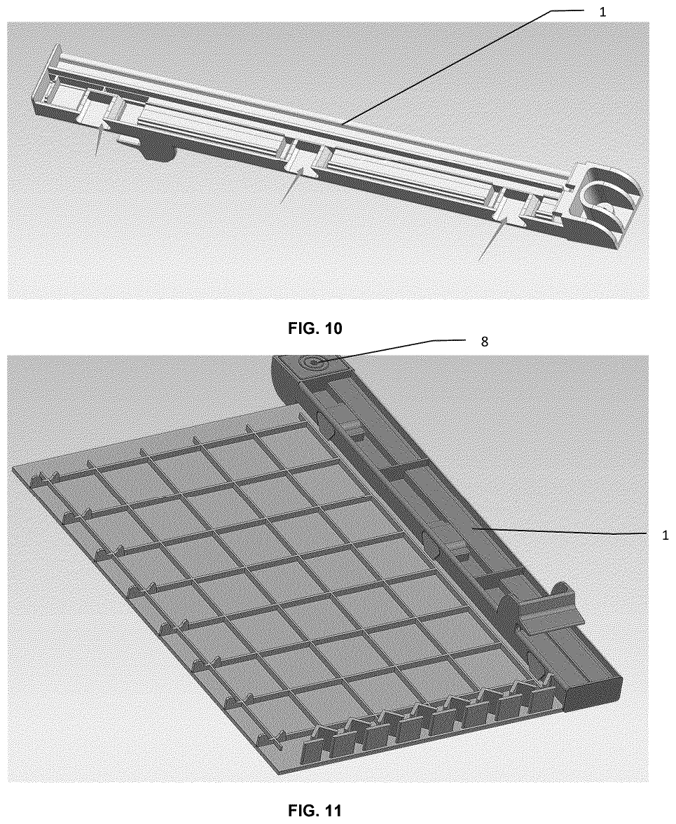

FIG. 10 shows the right-hand profile from FIG. 1. Three reception sections marked by red arrows can be seen distributed over the longitudinal direction for lateral insertion of a panel with corresponding mushroom-shaped projections, as shown in the final result in FIG. 11, to form the right-hand structural element from FIG. 1.

The underside is formed here by the end faces of the outer webs running in the longitudinal direction and connecting perpendicularly to this. The supporting section and the sealing ribs around the recess protrude from this.

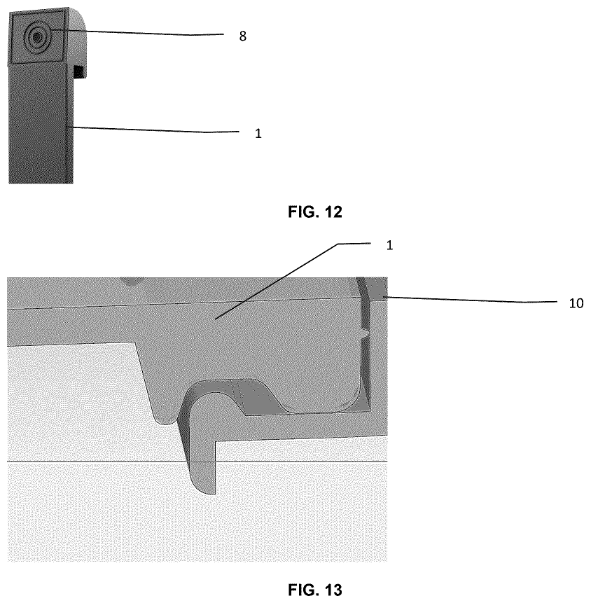

FIG. 12 shows a detail view of the profile from FIG. 6 in which the sealing ribs around the recess can be seen better.

FIG. 13 shows a left-hand part of a first profile on the right of the figure, and a solar cell array with second profile on the left of the figure. The second profile has small lugs, one of which can be seen. These serve as spacers during installation and can be elastically deformed and pressed into the second profile when the structural elements expand thermally.

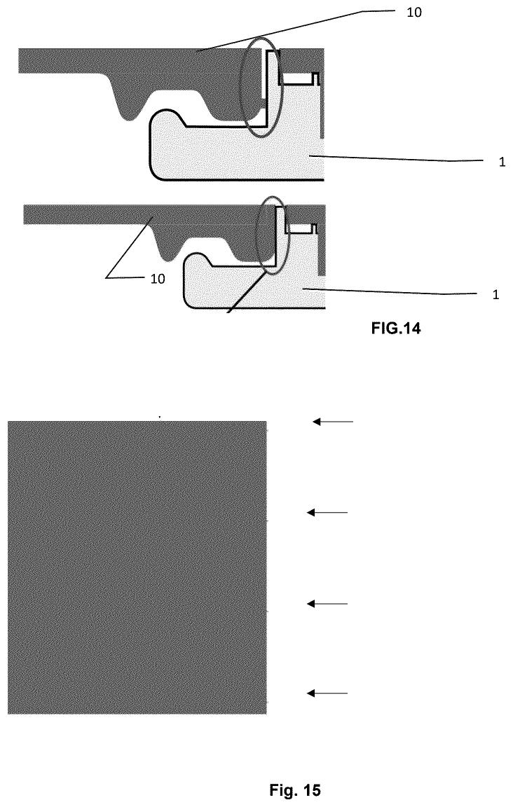

FIG. 14 illustrates this process from top to bottom.

FIG. 15 illustrates the size and distribution of the lugs in a view looking onto the solar cell array. The lugs are indicated by arrows.

1. A profile for covering a roof with panel-shaped roof coverings, wherein the profile comprises:
at least one recess through which a screw can be inserted from one upper side to one underside of the profile;
a longitudinal extension and at least one reception section for a roof covering that extends from the reception section in particular to one side of the profile, or is connected to such a reception section;
at least one sealing element on the upper side of the profile extending in the direction of the longitudinal extension;
a limiting element on the underside of the profile designed to engage around a panel-shaped element and thus limit the sliding of the profile onto the panel-shaped element, formed by a spacer section projecting from the underside and a section for engagement behind the panel projecting therefrom in the direction of the longitudinal extension of the profile;
a protruding supporting section on the underside of the profile that protrudes further from the underside than the limiting element; and
wherein the at least one recess runs in the direction of the longitudinal extension of the profile on the side of the spacer section or the protruding supporting section facing away from a rear engagement section.

2. The profile according to claim 1, wherein the reception section has at least one groove running in the longitudinal direction to take adhesive for bonding the panel-shaped roof covering or wherein the reception section is designed for drainage in the longitudinal direction by forming a groove running in the longitudinal direction.

3. (canceled)

4. The profile according to claim 1, wherein the reception section comprises, towards the end of the longitudinal extension facing away from the at least one recess or at the end of the longitudinal extension, a limiting section extending perpendicular to the longitudinal extension or, towards the at least one recess, a second rear engagement section extending away from the at least one recess.

5. The profile according to claim 4, wherein the at least one recess is arranged in a fastening section projecting from the upper side, from which the second rear engagement section extends or which is formed with a rounded end.

6. The profile according to claim 1, wherein the profile has a second reception section for a panel-shaped roof covering that is directly adjacent to the first reception section, is formed parallel thereto or has the same length or has a limiting section extending perpendicularly to the longitudinal extension towards the end of the longitudinal extension facing away from the recess or has a second rear engagement section towards the recess extending away from the recess.

7. The profile according to claim 1, wherein the protruding supporting section is formed with a rounding that extends over the entire height of the protruding supporting section or on the side of the protruding supporting section facing away from the rear engagement section or wherein the profile has a flat bar-shaped base body that defines the upper and lower sides as well as the longitudinal extension.

8. (canceled)

9. The profile according to claim 1, wherein the profile has on one underside at least one sealing device around the recess.

10. The profile according to claim 1, in which the reception section is designed in such a way that when the underside of the profile is screwed onto a panel, the panel-shaped element held is prevented from lifting off perpendicular to the panel surface or wherein the reception section is designed in such a way that a reception space limited towards the upper side and is formed between the underside of the profile and the upper side of the profile.

11. The profile according to claim 1, wherein the profile is made of plastic or wherein the profile is connected to a solar cell array accommodated in the reception section with the supporting section extending at least 5 mm behind the solar cell array; wherein the profile is connected to a plastic panel held in the reception section with the supporting section extending to at least 5 mm behind the solar cell array or having a grid extending perpendicular to the longitudinal extension of the profile and arranged at the end of the longitudinal extension facing away from the recess.

12. (canceled)

13. (canceled)

14. (canceled)

15. (canceled)

16. The profile according to claim 1, wherein the reception section is designed for insertion of a panel-shaped element and has clamping elements protruding into the reception space or wherein the profile or the reception section has expansion compensation lugs projecting perpendicularly to the longitudinal extension and perpendicularly to the direction from the upper to the underside or wherein the reception section has a lateral boundary designed such that it permits a lateral movement of the received panel-shaped element of at least 0.5 mm.

17. (canceled)

18. A system comprising at least one profile according to claim 1 and at least one panel-shaped roof covering.

19. A system comprising two profiles, with the first profile being a profile according to claim 1 and wherein the second profile is a profile for covering a roof with panel-shaped roof coverings, and the second profile comprises:
an upper side and an underside and a longitudinal extension in the order of 10 cm less than the longitudinal extension of the first profile up to the longitudinal extension of the first profile;
a longitudinal extension and over at least 50% of the longitudinal extension between upper and lower sides, and at least one reception section for a roof covering, or is connected to such a reception section; and
at least one sealing element along the longitudinal extension on the underside of the second profile and extending in the direction of the longitudinal extension at least one sealing element.

20. The system according to claim 19, wherein the second profile has a grid extending perpendicular to the longitudinal extension of the profile and arranged at the end of the longitudinal extension.

21. The system according to claim 19, wherein the second profile is designed such that the reception section running in the longitudinal direction has at least one groove to take adhesive for bonding the panel-shaped roof covering or wherein the second profile is designed such that the reception section has a limiting section extending perpendicular to the longitudinal extension at one or both ends of its longitudinal extension or wherein the second profile has a flat bar-shaped base body that defines the upper and lower sides as well as the longitudinal extension.

22. (canceled)

23. (canceled)

24. (canceled)

25. (canceled)

26. The system according to claim 19, wherein the second profile is integrally formed with or connected to a plastic panel, the panel having a grid extending perpendicularly to the longitudinal extension of the profile arranged at the end of the longitudinal extension facing away from the recess.

27. (canceled)

28. The system according to claim 19, further comprising: at least one solar cell array or panel-shaped element made of plastic.

29. The system according to claim 19, further comprising: at least two first and two second profiles and at least one solar cell array and a panel-shaped element made of plastic.

30. The system according to claim 29, wherein the first or the second profile is formed in one piece with the panel-shaped element made of plastic or wherein the first profile, the second profile, the base body of the first profile or second profile, the rear engagement section, the supporting section or the spacer section have a width in the range from 1 to 10 cm or wherein the first profile, the second profile, the base body of the first profile or second profile or the system has a length in the range from 20 to 150 cm or wherein the system has a width in the range from 50 to 150 cm.

31. (canceled)

32. (canceled)

33. (canceled)

34. (canceled)

35. A profile or system according to claim 1, wherein the profile is connected to a plastic panel held in the reception section wherein the plastic panel has ribs for stiffening or wherein the profile has latching means for securing a panel-shaped roof covering in the reception section against removal from the reception section.

36. (canceled)
